(19) United States
(12) Patent Application Publication
(10) Pub. No.: US 2024/0332863 A1
(43) Pub. Date: Oct. 3, 2024

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: Ming ZHOU, Kunshan (CN); Wei-Yang CHEN, New Taipei (TW); Chun-Hsiung HSU, New Taipei (TW)

(21) Appl. No.: 18/612,096

(22) Filed: Mar. 21, 2024

(30) Foreign Application Priority Data
Mar. 28, 2023 (CN) 202320638171.1

(51) Int. Cl. H01R 13/6471; H01R 12/71

(52) U.S. Cl. CPC H01R 13/6471; H01R 12/716

(57) ABSTRACT

An electrical connector including: an insulative housing; and plural conductive terminals contained in the insulating housing, the conductive terminals being arranged in a row along a transverse direction, each of the conductive terminals including a mating portion and a tail portion opposite to the mating portion, the conductive terminals including a pair of ground terminals and a pair of signal terminals disposed between the pair of ground terminals, wherein a center distance between adjacent tail portions of the conductive terminals is not equal.

### BACKGROUND OF THE INVENTION

### Field of the Invention

The present invention relates generally to an electrical connector, and particularly to an electrical connector suitable for transmitting high-speed signals.

### Description of Related Arts

U.S. Pat. No. 8,764,464 discloses an electrical connector comprising a plurality of terminals which include at least a pair of signal terminals and two ground terminals arranged on two sides of the pair of signal terminals. A ground coupling member is electrically connected to the ground terminal to adjust the electrical performance of the electrical connector. However, as the transmission rate increases, the role of ground coupling member in adjusting electrical performance is limited.

An improved electrical connector is desired.

### SUMMARY OF THE INVENTION

The objective of the present invention is to provide an electrical connector capable of transmitting high-speed signals.

To achieve the above object, an electrical connector comprises: an insulative housing; and a plurality of conductive terminals contained in the insulating housing, the plurality of conductive terminals being arranged in a row along a transverse direction, each of the conductive terminals including a mating portion and a tail portion opposite to the mating portion, the plurality of conductive terminals including a pair of ground terminals and a pair of signal terminals disposed between the pair of ground terminals, wherein a center distance between adjacent tail portions of the conductive terminals is not equal.

Compared to prior art, in the electrical connector of the present invention, the center distances between the tails of adjacent conductive terminals are unequal to meet the characteristic impedance of transmitting high-speed signals, thereby facilitating the transmission of high-speed signals.

### BRIEF DESCRIPTION OF THE DRAWING

FIG. 1 is a perspective view of an electrical connector according to the present invention mounted on an external circuit board;

FIG. 2 is an exploded view of the electrical connector of FIG. 1;

FIG. 3 is another exploded view of the electrical connector of FIG. 2;

FIG. 4 is a side view of terminal module of the electrical connector of FIG. 2;

FIG. 5 is an exploded view of the terminal module of FIG. 4;

FIG. 6 is another exploded view of the terminal module of FIG. 5;

FIG. 7 is a further exploded view of the terminal module of FIG. 5;

FIG. 8 is another exploded p view of the terminal module of FIG. 7;

FIG. 9 is a perspective view of the first row of terminals, the first fixing member, the second row of terminals and the second fixing member of the terminal module of FIG. 7;

FIG. 10 is a top view of the first row of terminals of FIG. 9;

FIG. 11 is a rear view of the first row of terminals of FIG. 10;

FIG. 12 is a cross-sectional view taken along line A-A of the electrical connector of FIG. 1 mounted on the external circuit board;

FIG. 13 is a cross-sectional view taken along line B-B of the electrical connector of FIG. 1 mounted on the external circuit board;

FIG. 14 is a perspective view of another embodiment of an electrical connector according to the present invention;

FIG. 15 is an exploded view of the electrical connector of FIG. 14;

FIG. 16 is another exploded view of the electrical connector of FIG. 15;

FIG. 17 is a side view of the terminal module of the electrical connector of FIG. 14;

FIG. 18 is a cross-sectional view of the electrical connector of FIG. 14 mounted on an external circuit board taken along a vertical direction to show that one ground terminal of the second row of terminals is in contact with the shielding plate; and

FIG. 19 is a cross-sectional view of the electrical connector of FIG. 14 mounted on an external circuit board taken along a vertical direction to show that one ground terminal of the first row of terminals is in contact with the shielding plate.

### DETAILED DESCRIPTION OF THE PREFERRED EMBODIMENT

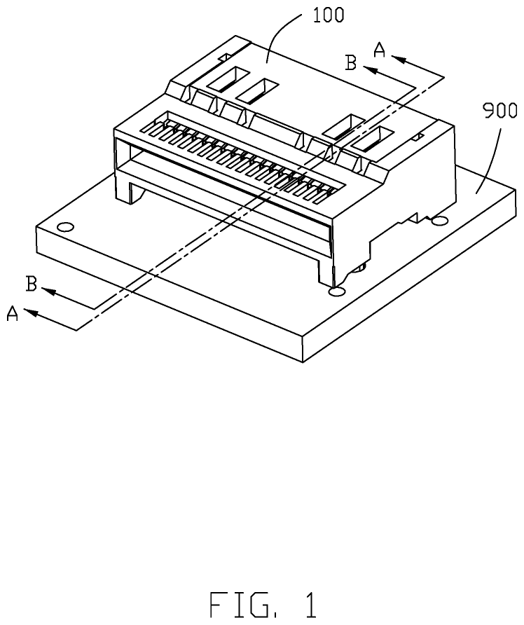

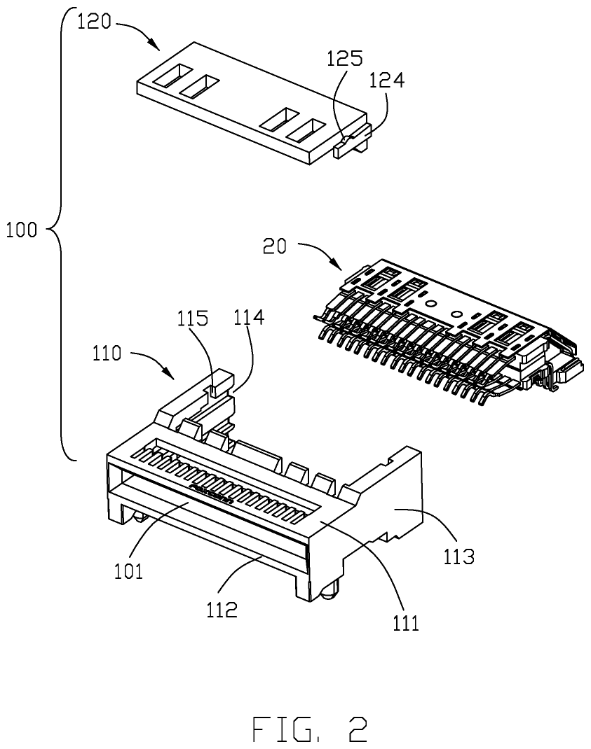

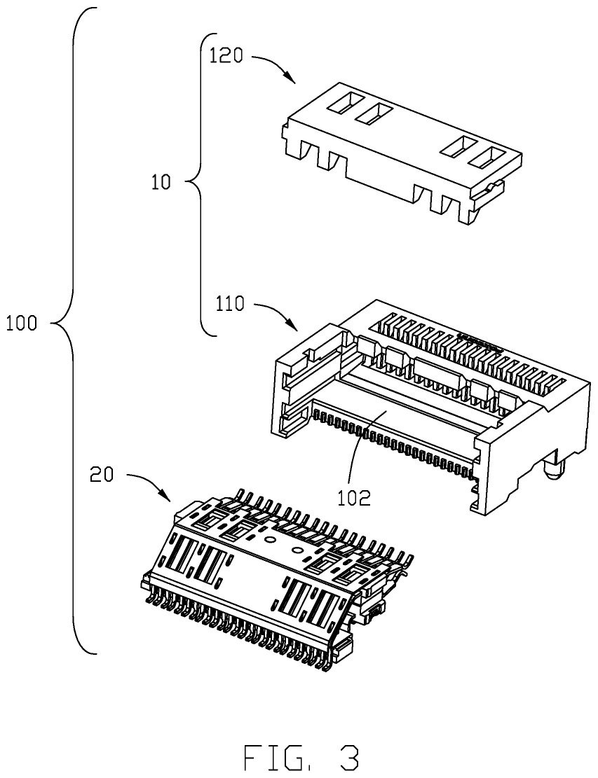

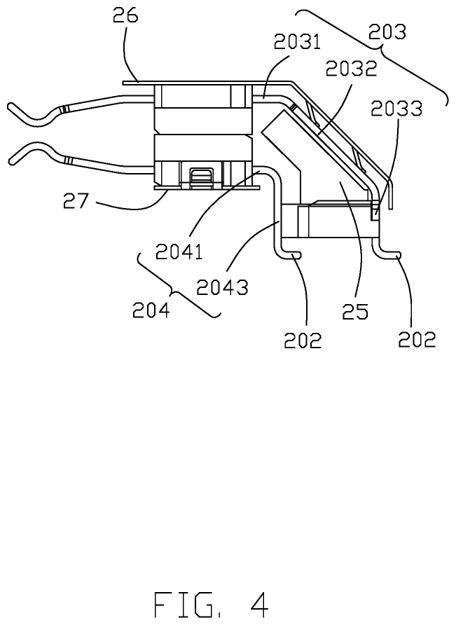

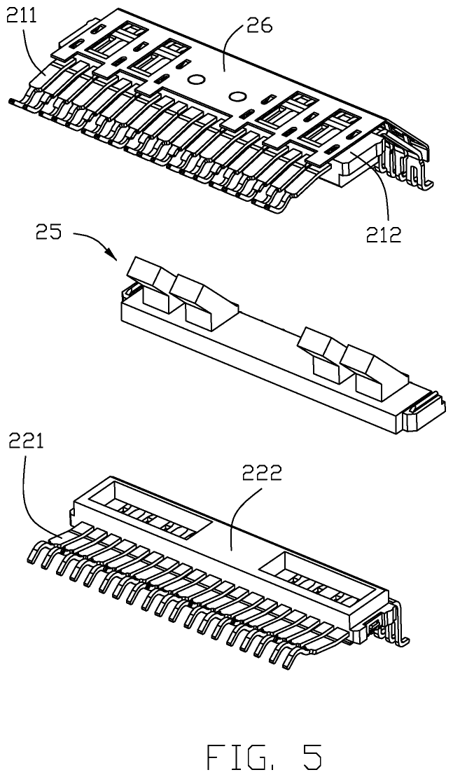

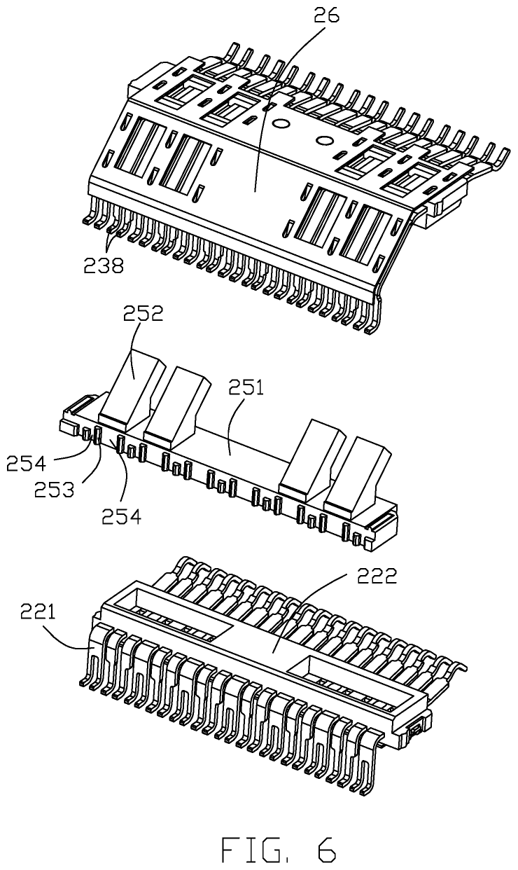

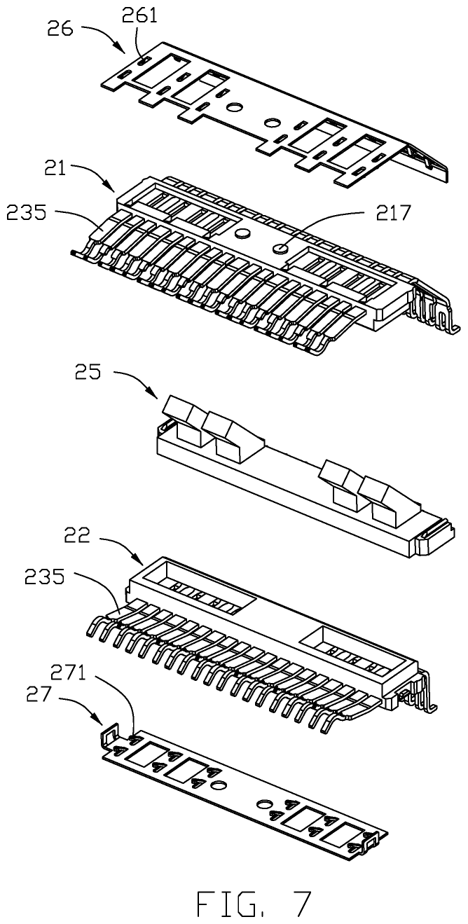

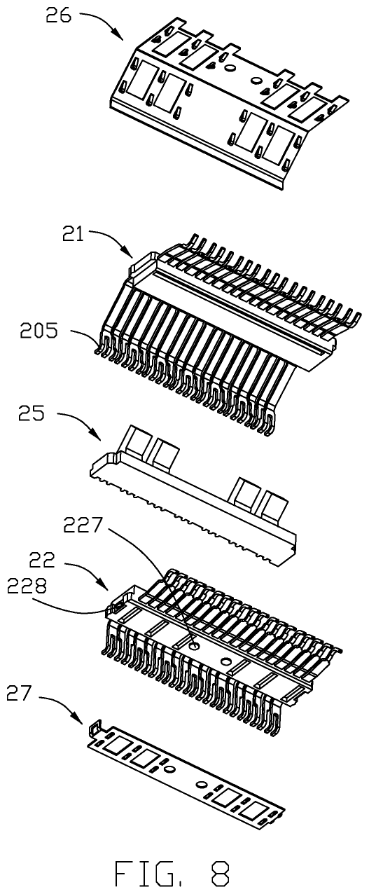

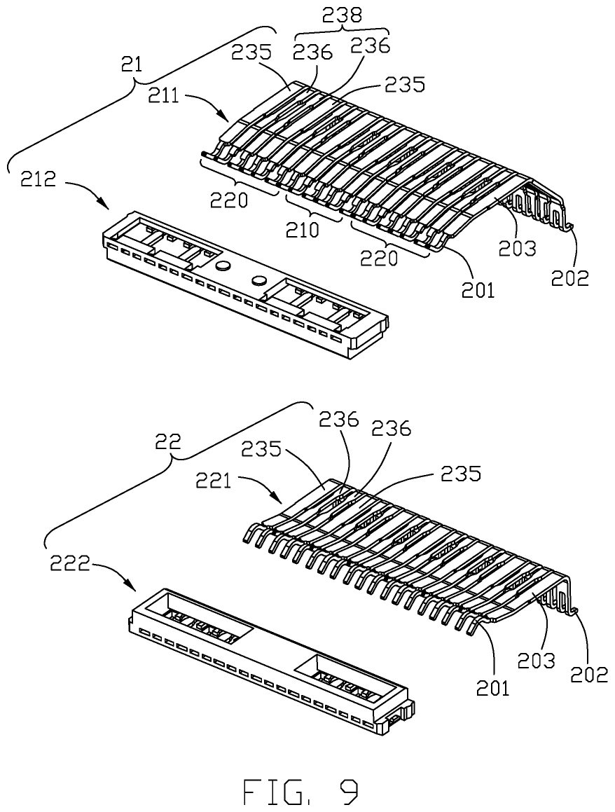

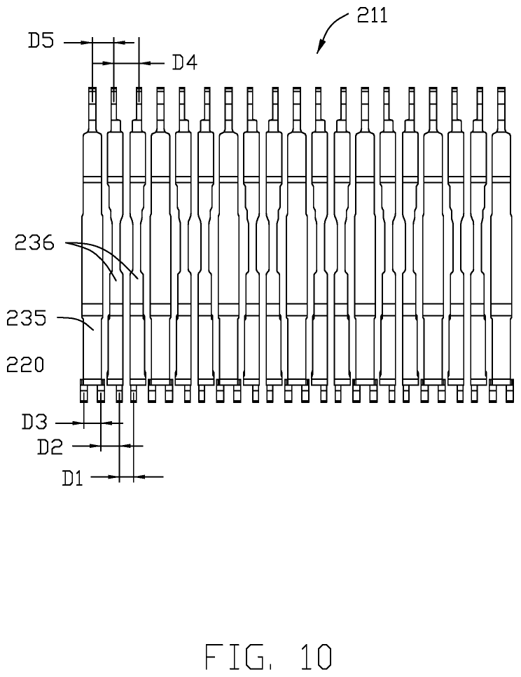

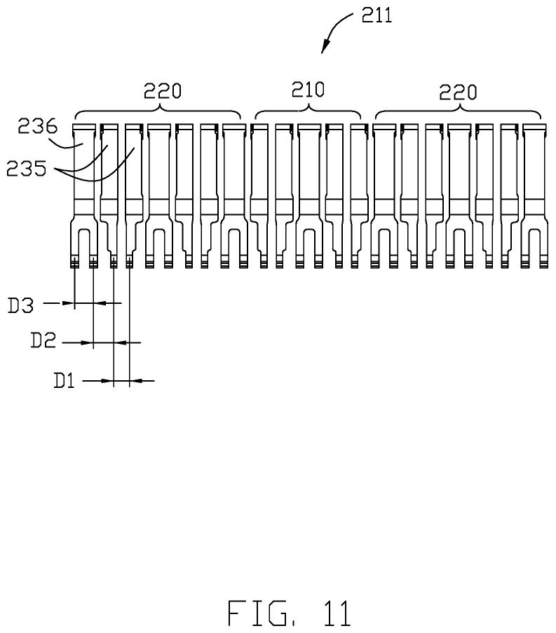

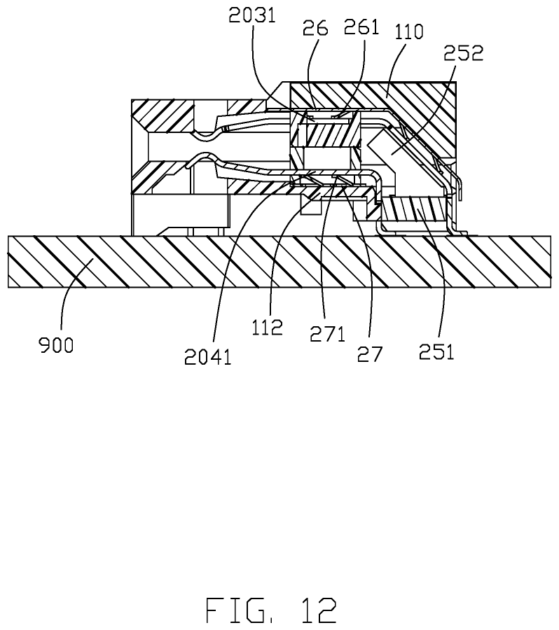

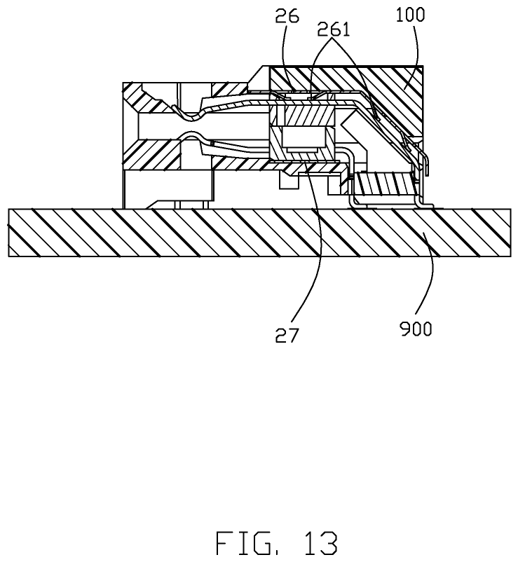

Referring to FIGS. 1-13, an electrical connector 100 in accordance with the present invention and an external circuit board 900 capable of mating with the electrical connector 100 is shown. The electrical connector 100 (not shown) can be inserted and matched with the mating tongue (not shown) of the mating connector along the insertion direction, and can be mounted on the external circuit board 900 along the vertical direction perpendicular to the insertion direction. The electrical connector 100 comprises an insulative housing 10 and a terminal module 20 received in the insulative housing 10.

The insulative housing 10 includes a body part 110 and an upper cover 120 that cooperates with the body part 110. The body part 110 has a mating slot 101 for the mating tongue to be inserted, and an installation opening 102 for the terminal module 20 to be installed from back to front. A top wall 111 is provided on the upper side of the mating slot 101, a bottom wall 112 is provided on the lower side of the mating slot 101, and the two side walls 113 connecting the top wall 111 and the bottom wall 112. The two side walls 113 extend rearward beyond the bottom wall 112. A plurality of installation grooves 114 are provided on the inner side of the two side walls 113. The upper cover 120 has outwardly protruding ribs 124 on two sides in the transverse direction. Each of the protruding ribs 124 has a convex bump 125 protruding upward. The side wall 113 has a locking groove 115 that communicates with the installation groove 114 in the up and down direction. There is an interference fit between the convex bump 125 and the locking groove 115. Specifically, the interference between the convex bump 125 and the locking groove 115 is 0.16 mm.

The terminal module 20 includes a first terminal group 21 and a second terminal group 22. The first terminal group 21 includes a first row of terminals 211 arranged in a transverse direction and a first fixing member 212 for fixing the first row of terminals 211. The second terminal group 22 includes a second row of terminals 221 arranged in a transverse direction and a second fixing member 222 for fixing the second row of terminals 221. The first fixing member 212 and the second fixing member 222 are stacked with each other in the vertical direction, so that the first row of terminals 211 and the second row of terminals 221 are spaced apart in the vertical direction.

Each terminal in the first row of terminals 211 and the second row of terminals 221 includes a mating portion 201 mated with a mating connector, a tail portion 202 opposite to the mating portion 201, and a transition portion therebetween. The first row of terminals 211 is on the upper side of the mating slot 101, and the second row of terminals 221 is on the lower side of the mating slot 101. When the mating tongue is inserted into the mating slot 101, the mating portion 201 of the first row of terminals 211 can elastically deform upward, and the mating portion 201 of the second row of terminals 221 can elastically deform downward.

The transition portion 203 of each terminal of the first row of terminals 211 includes a first horizontal portion 2031 extending rearwardly from the mating portion 201, and an inclined portion 2032 extending obliquely downward and rearwardly from the first horizontal portion 2031, and a first vertical portion 2033 connecting the inclined portion 2032 and the tail portion 202. The transition portion 204 of each terminal of the second row of terminals 221 includes a second horizontal portion 2041 extending rearwardly from the mating portion 201, and a second vertical portion connecting the second horizontal portion 2041 and the tail portion 202. The first fixing member 212 is integrally formed on the first horizontal portion 2031, and the second fixing member 222 is integrally formed on the second horizontal portion 2041.

Each of the first row of terminals 211 and the second row of terminals 221 include a low-speed terminal area 210 and a pair of high-speed terminal areas 220 arranged on two sides of the low-speed terminal area 210. Each of the high-speed terminal areas 220 includes at least one pair of ground terminals 235 and a pair of signal terminals 236 disposed between the pair of ground terminals 235. A pair of signal terminals 236 forms a signal terminal pair 238. Specifically, each of the high-speed terminal areas 220 includes two pairs of signal terminals 236 and three ground terminals 235.

The arrangement of the first row of terminals 211 is substantially the same as that of the second row of terminals 221, except that the overall size of the terminals is larger than that of the second row of terminals 221. Take the first row of terminals 211 as an example. Each ground terminal 235 has multiple tail portions 202, and each signal terminal 236 has only one tail portion 202. Specifically, each ground terminal 235 has two tail portions 202. The center distance between the tail portions 202 of adjacent conductive terminals is not equal. There is a first center distance D1 between the tail portions 202 of a pair of signal terminals. There is a second center distance D2 between the tail portion 202 of a ground terminal 235 and a tail portion 202 of the adjacent signal terminal 236. The first center distance D1 is smaller than the second center distance D2. The first center distance D1 is not greater than 0.5 mm, and the second center distance D2 is not less than 0.65 mm. Specifically, the first center distance D1 is 0.5 mm, and the second center distance D2 is 0.65 mm, or the first center distance D1 is 0.4 mm, and the second center distance D2 is 0.7 mm. There is a third center distance D3 between the two tail portions 202 of one ground terminal 235. The third center distance D3 is greater than the first center distance D1 and less than the second center distance D2. Specifically, the third center distance D3 is 0.6 mm. There is a fourth center distance D4 between the mating portions 201 of a pair of signal terminals. There is a fifth center distance D5 between the mating portion 201 of a ground terminal 235 and the mating portion 201 of the adjacent signal terminal 236. The fourth center distance D4 is greater than the fifth center distance D5. Specifically, the fourth center distance is 0.89 mm, and the fifth center distance is 0.76 mm. Center distance refers to the distance between the center line of one terminal and the center line of the corresponding position of the adjacent terminal. The center distance of adjacent terminals in the second row of terminals 221 is the same as that of the first row of terminals 211.

The terminal module 20 further includes a spacer 25. The spacer 25 is disposed between the first row of terminals 211 and the second row of terminals 221 and is close to the area of the tail portions 202. The spacer 25 makes the positions of the tail portions 202 of the first row of terminals 211 and the second row of terminals 221 relatively fixed to facilitate installation of the tail portions onto the conductive pad (not shown) of the external circuit board 900. Specifically, the spacer 25 includes a main body portion 251 and a plurality of protruding portions 252 extending from the main body portion 251. The first vertical portion 2033 and the second vertical portion 2043 abut against two opposite sides of the main body portion 251. The main body portion 251 has a plurality of rearwardly protruding grids 253 on the side close to the first vertical portion 2033 and limiting grooves 254 are formed between adjacent grids 253. A slot 205 is formed between the two tail portions 202 of one ground terminals 235. The slot 205 extends from the tail portion 202 of the ground terminal 235 to the first vertical portion 2033, dividing the corresponding portion of the ground terminal 235 into two parts spaced apart in the transverse direction. The first vertical portion 2033 of each terminal in the first row of terminals 211 is limited in the corresponding limiting groove 254. The tail portions 202 of a pair of signal terminals are received in the same limiting groove 254, and the two parts of the first vertical portion 2033 of a ground terminal 235 are respectively received in two adjacent limiting grooves 254. The plurality of protruding portions 252 are close to and facing the corresponding signal terminal pairs 238 of the first row of terminals 211. The protruding portion 252 is inclined to match the inclination of the inclined portion 2032. The width of the protruding portion 252 along the transverse direction is greater than the width of the corresponding signal terminal pair 238 along the transverse direction. The protruding portion 252 does not contact the signal terminal pair 238. Since the first row of terminals 211 is longer and has many bending features, the protruding portion 252 is used to change the dielectric coefficient value of the corresponding signal terminal area, thereby increasing the capacitance value of the signal terminal area, and reducing the impedance of the signal terminal pair 238, so that the electrical connector 100 has better performance in transmitting high-speed signals.

The terminal module 20 further includes a first shielding plate 26 installed on the upper side of the first fixing member 212 and a second shielding plate 27 installed on the lower side of the second fixing member 222. The top of the first fixing member 212 has a first positioning boss 217 for mounting the first shielding plate 26, and the second fixing member 222 has a second positioning boss 227 for mounting the second shielding plate 27. The second fixing member 222 has buckling portions 228 on two sides in the transverse direction that snap with the sides of the second shielding plate 27. The first shielding plate 26 includes a plurality of first contact elastic pieces 261 formed by integral stamping. The first shielding plate 26 and the ground terminals 235 in the upper row are mechanically and electrically connected through the first contact elastic piece 261. The second shielding plate 27 includes a plurality of second contact elastic pieces 271 formed by integral stamping. The second shielding plate 27 is mechanically and electrically connected to the ground terminals 235 in the lower row through the second contact elastic pieces 271. The upper cover 120 exerts a force on the first shielding plate 26 toward the ground terminal. The bottom wall 112 of the insulative housing 10 exerts a force on the second shielding plate 27 toward the corresponding ground terminal, so that the shielding plate can reliably contact the corresponding ground terminal 235.

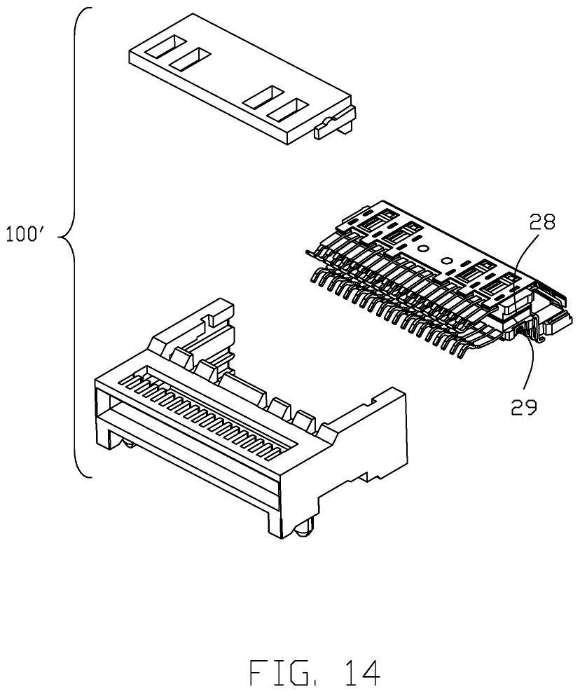

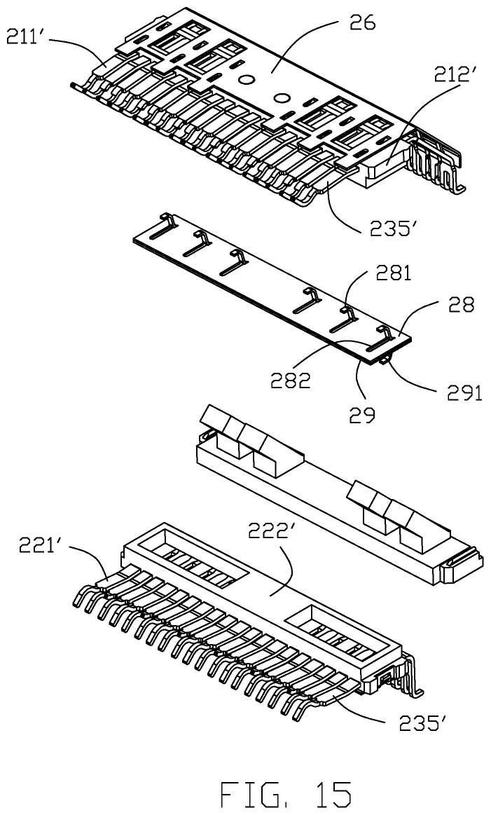

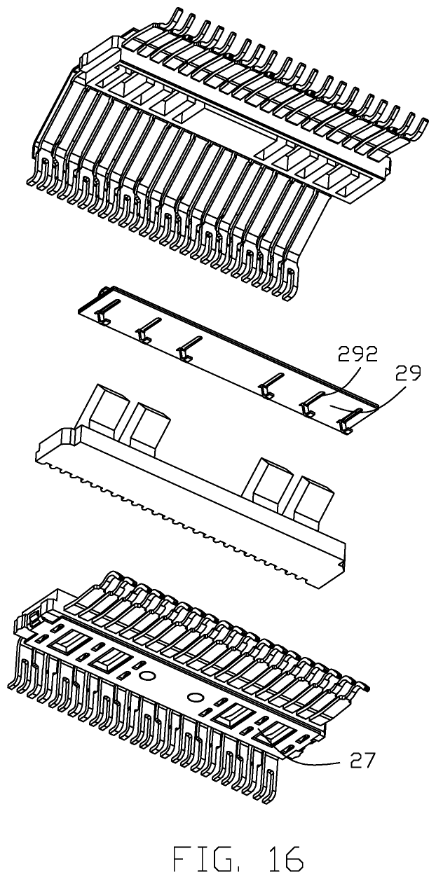

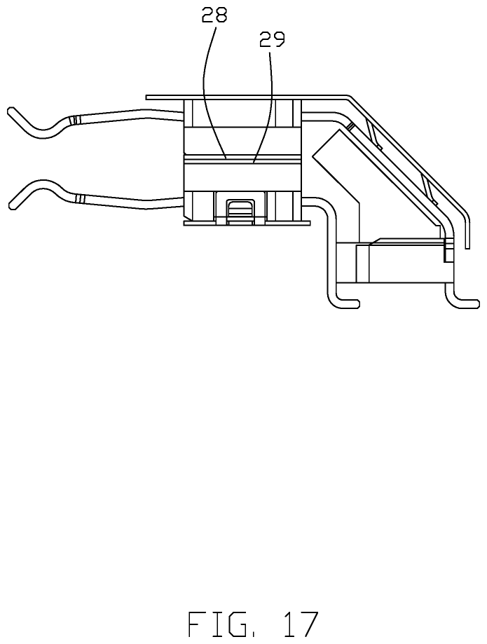

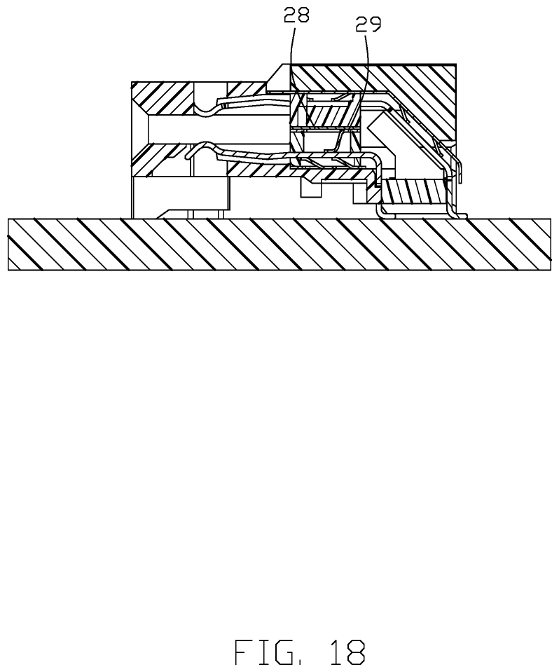

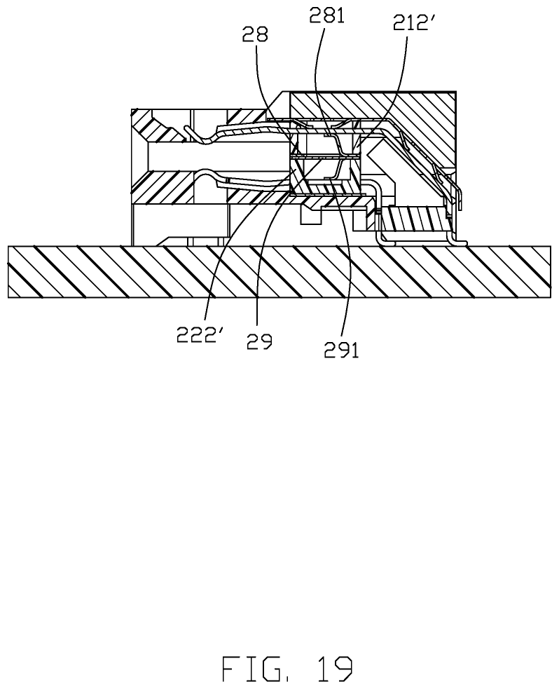

Referring to FIGS. 14-19, a second embodiment of the electrical connector 100′ of the present invention is shown. Compared with the first embodiment, in this embodiment, the electrical connector further includes an upper shielding plate 28 and a lower shielding plate 29 disposed between the first fixing member 212′ and the second fixing member 222′. The upper shielding plate 28 includes a plurality of upper contact elastic pieces 281, and the lower shielding plate 29 includes a plurality of lower contact elastic pieces 291. The upper contact elastic piece 281 passes through the opening on the first fixing member 212′ and is mechanically and electrically connected to the ground terminal 235′ of the first row of terminals 211′ to reduce crosstalk between adjacent differential pairs. The first row of terminals 211′ and the second row of terminals 221′ are staggered in the transverse direction. The upper hole 282 formed by punching the upper contact elastic piece 281 and the lower hole 292 formed by punching the corresponding lower contact elastic piece 291 are staggered in the transverse direction. Therefore, after the upper shielding plate 28 and the lower shielding plate 29 are attached, there is no opening in the up and down direction to completely isolate the first row of terminals 211′ and the second row of terminals 221′ in the vertical direction, thereby reducing crosstalk between the two rows of terminals. The upper shielding plate 28 is electrically connected to the first shielding plate 26 through the upper row of ground terminals 235′. The lower shielding plate 29 is electrically connected to the second shielding plate 27 through the lower row of ground terminals 235′. The upper shielding plate 28 and the lower shielding plate 29 are attached to each other and connected mechanically and electrically.

The electrical connector of the present invention adjusts the center distance between the tails of the terminals so that the impedances of the terminals are matched when transmitting signals, and has better electrical performance, thereby facilitating the transmission of high-speed signals.

The electrical connector of the present invention conforms to the specification of QSFP, which defines eight transmitting channels and eight receiving channels, the signal transmission rate of each channel can reach 112 Gbps or above. Of course, the transmission rate of the present invention is not limited to 112 Gbps, and can also be applied to transmission at higher or lower rates. Of course, the present invention can also be applied electrical connector such as SFP-DD, SFP, QSFP-DD, etc.

1. An electrical connector comprising:
an insulative housing; and
a plurality of conductive terminals contained in the insulating housing, the plurality of conductive terminals being arranged in a row along a transverse direction, each of the conductive terminals including a mating portion and a tail portion opposite to the mating portion, the plurality of conductive terminals including a pair of ground terminals and a pair of signal terminals disposed between the pair of ground terminals; wherein
a center distance between adjacent tail portions of the conductive terminals is not equal.

2. The electrical connector as claimed in claim 1, wherein each of the ground terminals has multiple tails, and each of the signal terminals has only one tail.

3. The electrical connector as claimed in claim 2, wherein there is a first center distance between the tail portions of a pair of signal terminals, and a second center distance between the tail portions of the ground terminal and the tail portions of the adjacent signal terminals, the first center distance being smaller than the second center distance.

4. The electrical connector as claimed in claim 3, wherein the first center distance is not greater than 0.5 mm, and the second center distance is not less than 0.65 mm.

5. The electrical connector as claimed in claim 4, wherein the first center distance is 0.5 mm, and the second center distance is 0.65 mm.

6. The electrical connector as claimed in claim 4, wherein the first center distance is 0.4 mm, and the second center distance is 0.7 mm.

7. The electrical connector as claimed in claim 3, wherein each of the ground terminal has two tail portions, and there is a third center distance between the two tail portions of one ground terminal, the third center distance being greater than the first center distance and less than the second center distance.

8. The electrical connector as claimed in claim 7, wherein the third center distance is 0.6 mm.

9. The electrical connector as claimed in claim 1, wherein there is a fourth center distance between the mating portions of a pair of signal terminals and a fifth center distance between the mating portion of a ground terminal and the mating portion of the adjacent signal terminal, and the fourth center distance is greater than the fifth center distance.

10. The electrical connector as claimed in claim 9, wherein the fourth center distance is 0.89 mm, and the fifth center distance is 0.76 mm.

11. The electrical connector as claimed in claim 1, wherein the insulative housing includes a body part and an upper cover that cooperates with the body part.

12. The electrical connector as claimed in claim 11, wherein the body part has a mating slot, a top wall is provided on the upper side of the mating slot, a bottom wall is provided on the lower side of the mating slot, and two side walls connect the top wall and the bottom wall.

13. The electrical connector as claimed in claim 12, wherein the upper cover has outwardly protruding ribs on two sides thereof in the transverse direction, each of the protruding ribs has a convex bump protruding upward, and the side wall has a locking groove interfere fit with the convex bump.

14. The electrical connector as claimed in claim 13, wherein the interference between the convex bump and the locking groove is about 0.16 mm.
